(19) United States
(12) Patent Application Publication
(10) Pub. No.: US 2013/0197883 A1
(43) Pub. Date: Aug. 1, 2013

(54) CREATING A SYSTEM EQUILIBRIUM VIA UNKNOWN FORCE(S)

(71) Applicant: AUTODESK, INC., San Rafael, CA (US)

(72) Inventors: Lance Wilson Grow, Tigard, OR (US); Zdenek Slavik, Decin 1 (CZ); Jirka Stejskal, Decin (CZ)

(73) Assignee: AUTODESK, INC., San Rafael, CA (US)

(21) Appl. No.: 13/755,833

(22) Filed: Jan. 31, 2013

Related U.S. Application Data
(60) Provisional application No. 61/592,977, filed on Jan. 31, 2012.

(51) Int. Cl. G06F 17/50

(52) U.S. Cl. CPC G06F 17/5009
USPC 703/2

(57) ABSTRACT

A method, apparatus, system, article of manufacture, and computer readable storage medium provide the ability to solve a not-statically determinate modeling system. A free body diagram (FBD) with a degree of freedom (DOF) greater than zero is obtained. For each beam in the FBD that has more than one DOF, a point of beam that is movable is discovered. A variable force is applied at the point. A DOF of the FBD is determined based on the application of the variable force. Based on the determining, a size of the variable force that places the FBD in equilibrium is computed.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/592,977, filed on Jan. 31, 2012, by Lance Grow, Zdenek Slavik, and Jirka Stejskal, entitled “Creating a System Equilibrium Via Unknown Force(s),” attorneys' docket number 30566.490-US-P1.

This application is related to the following co-pending and commonly-assigned patent applications, which applications are incorporated by reference herein:

U.S. patent application Ser. No. ______, entitled “GRAPH BASED DEGREE OF FREEDOM COUNTER FOR TWO DIMENSIONAL DRAWINGS”, filed on the same date herewith by Michal Hrcka, and Lance Wilson Grow, Attorney Docket No. 30566.488-US-U1, which application claims priority to Provisional Application Ser. No. 61/592,960, filed on Jan. 31, 2012, by Michal Hrcka and Lance Wilson Grow, entitled “Graph Based Degree of Freedom Counter for Two Dimensional Drawings,” attorneys' docket number 30566.488-US-P1; and

U.S. patent application Ser. No. ______, filed on the same data herewith, entitled “MATCHING A SYSTEM CALCULATION SCALE TO A PHYSICAL OBJECT SCALE”, by Michal Hrcka, Lance Wilson Grow, and David Obergries Attorney Docket No. 30566.489-US-U1, which application claims priority to U.S. Provisional Patent Application Ser. No. 61/592,972, filed on Jan. 31, 2012, entitled “MATCHING A SYSTEM CALCULATION SCALE TO A PHYSICAL OBJECT SCALE”, by Michal Hrcka, Lance Grow, and David Obergries Attorney Docket No. 30566.489-US-P1; and

### BACKGROUND OF THE INVENTION

1. Field of the Invention

The present invention relates generally to mechanical and civil engineering, and in particular, to a method, apparatus, and article of manufacture for applying an unknown/variable force to solve a modeling system that is not statically determinate.

2. Description of the Related Art

Engineers often utilize free body diagrams (FBD) that represent a simplified engineering construction or a mechanism that is connected to a fixed frame. In such FBDs, a mechanism may be connected to a frame using supports. It is desirable to determine the reactions in the points of support and also forces in points where two or more components connect together. However, prior art systems require a statically determinate system to determine such reactions and forces. Accordingly, it is desirable to perform various evaluations on a system that is not statically determinate with a minimum amount of effort by the engineer. To better understand such problems, a description of prior art FBDs and the evaluation of forces on such FBDs may be useful.

As described above, usually, FBDs represent simplified engineering constructions, or a mechanism connected to fixed frame. A mechanism is connected to a frame (in a FBD) using supports. There are basically three types of such supports: (1) grounded support—that fixes the element completely; (2) fixed pin—that disables the element from shift but still allows the element to rotate around the point of connection; and (3) a sliding pin—that allows both rotation and shift in one direction (like rolling on or with the support). There are also external or internal loads on the mechanism (e.g., a mechanism's weight, or other mechanism pushing/pulling, wind, etc.).

An engineer often desires to determine the reactions in the points of supports as well as the forces in points where two or more components connect together. Traditionally, the evaluation of such forces is done using static equilibrium equations. For such a case to be solvable by means of static equilibrium equations, it has to be a statically determinate system, not a moving one. For example, if a construction has a beam that is fixed on one end to an axis, to calculate the effect of applying forces to the beam, one must add a support to the other end of the beam that prevents the beam from rotating. However, in reality, engineers are often modeling a mechanism that is not statically determinate. Alternatively, engineers may desire to perform a simplification of the system that leads to a mechanism that can rotate or even move. Such a system is referred to as having a non-zero Degree of Freedom (DOF). Again the evaluation of such a system in the prior art is not available because such prior art systems require a statically determinate system.

In view of the above, what is needed is the capability to determine and evaluate the result of applying forces to various points in a modeling system/FBD that has a degree of freedom that is greater than zero (0).

### SUMMARY OF THE INVENTION

In order to solve systems with a degree of freedom that is greater than zero (0) as if they are fixed, embodiments of the invention introduce the concept of a Variable Force. The point where the Variable Force acts is set/known. A force size is retrieved/determined such that when applied, the system will be in equilibrium (all loads, reactions in supports, and the variable force(s) will generate a system that stays in its position). Depending on how such a system is acted upon, the Variable Force can be given either a fixed angle of action and only its size is unknown, or both the angle and size can be retrieved from solving the system. Also, more than one Variable Force can be applied to the mechanism as needed.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIGS. 3A and 3B illustrate an example of two simple mechanisms in a free body diagram used in accordance with one or more embodiments of the invention;

FIG. 4A illustrates the application of a force F1 to the beam AB of FIG. 3A in accordance with one or more embodiments of the invention;

FIG. 4B illustrates the application of force F3 to termination point C on beam CD of 3B in accordance with one or more embodiments of the invention;

FIGS. 5A and 5B illustrate the application of variable forces F2, F4, and F5 (shown decomposed to the its x-axis and y-axis constituent parts) in accordance with one or more embodiments of the invention;

FIGS. 6A and 6B illustrate the application of both known and unknown forces as well as the resulting reactions (R) in the supports in accordance with one or more embodiments of the invention;

FIG. 7 illustrates a three beam construction where variable forces are used to calculate the various effects in accordance with one or more embodiments of the invention; and

FIG. 8 illustrates the logical flow for creating a system equilibrium using an unknown force(s) in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide the ability to apply unknown forces and solve for such forces in a static equilibrium equation (on a system that has a degree of freedom greater than zero). Both the mathematical approach used to solve the problems of the prior art as well as the solution methodology itself are unique and distinguishable from prior art approaches.

### Hardware Environment

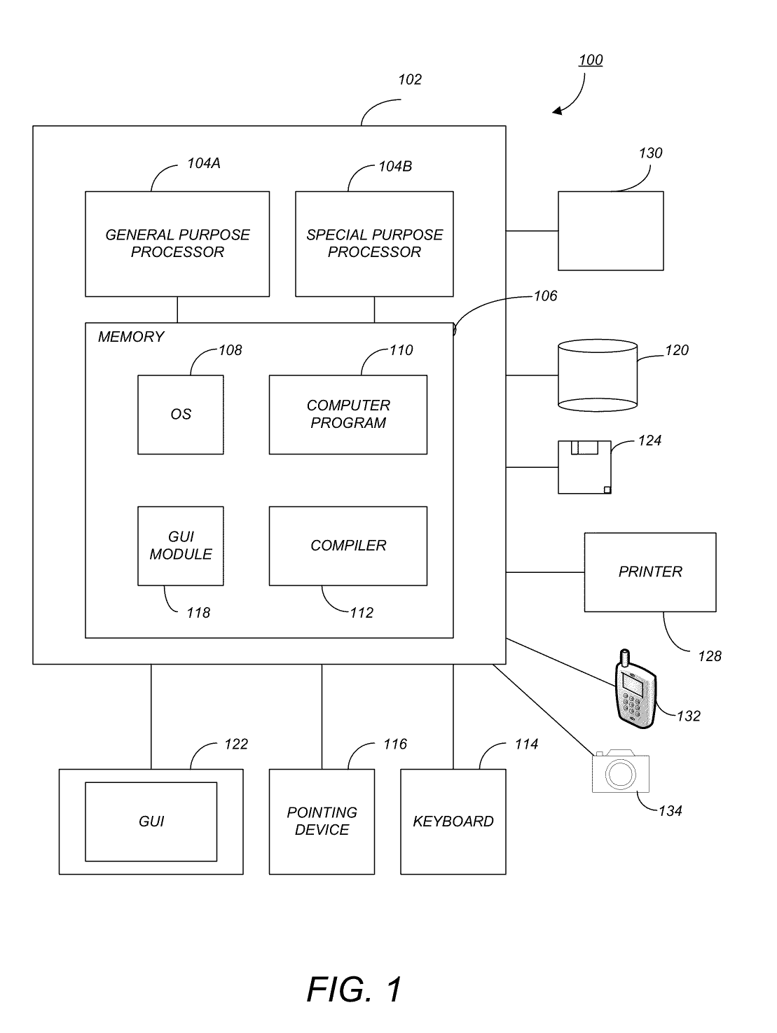

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128.

In one or more embodiments, computer 102 may be coupled to, or may comprise, a portable or media viewing/listening device 132 (e.g., an MP3 player, iPod™, Nook™, portable digital video player, cellular device, personal digital assistant, etc.).

In addition, computer 102 may be coupled to or may be integrated with an image capture device 134 (e.g., a camera, ultrasound, radar, x-ray, charge coupled device (CCD), complimentary metal oxide semiconductor (CMOS) device, or any device that is capable of capturing or generating an image of a real-world object). For example, many modern mobile phones and tablet devices may have a built in camera (e.g., lens) and other capabilities that enables the user to snap a picture/photograph.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Further, as described above, such multi-touch devices may also include a camera or the ability to capture an image of a desired object/scene. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communication devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

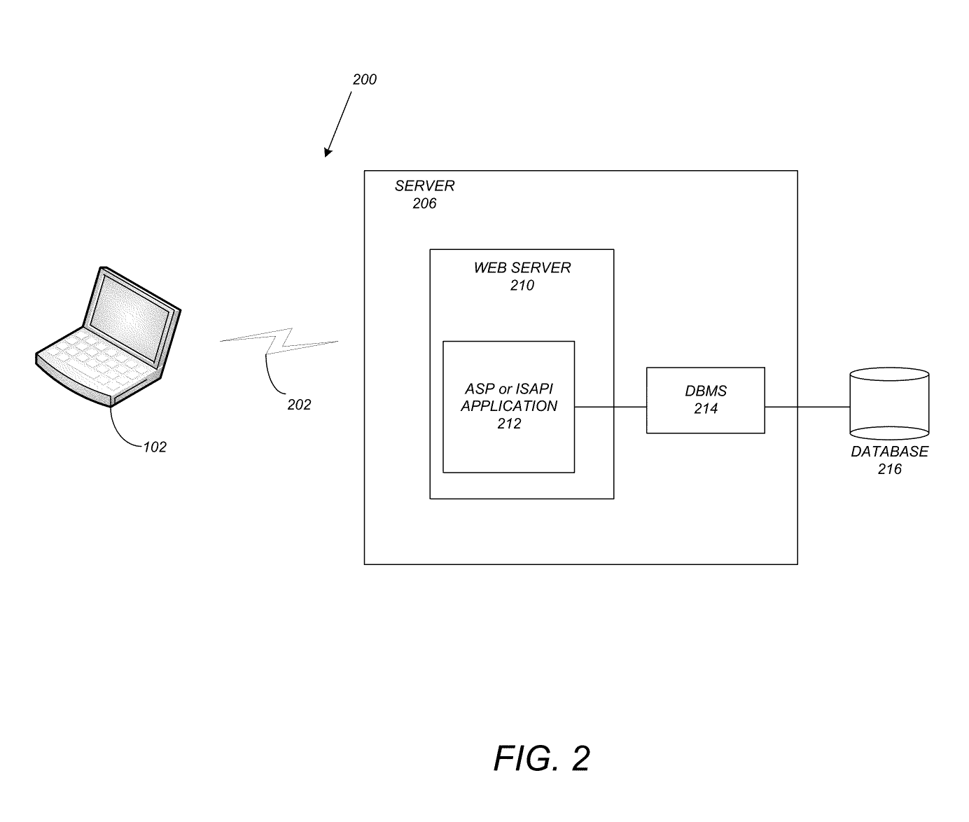

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1).

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug-in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNENT INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 102 and 206.

### Software Embodiments

Embodiments of the invention are implemented as a software application on a client 102 or server computer 206. Further, as described above, the client 102 or server computer 206 may comprise a thin client device or a portable device that has a multi-touch-based display and/or image capture functionality/capability.

Embodiments of the invention provide a unique experience for solving the prior art problems by applying an unknown/variable force and determining the force size that, when applied, will result in a system in equilibrium. In this regard, the concept is that the user is not required to physically place a system in a statically determinate state (e.g., by adding supports to a beam). Instead, an unknown force is utilized to determine how to balance a system (i.e., by determining how big the force needs to be).

The different types of joints and supports that may exist in a free body diagram are described in the applications cross referenced above including co-pending application Ser. No. ______, filed on the same date herewith, entitled “GRAPH BASED DEGREE OF FREEDOM COUNTER FOR TWO DIMENSIONAL DRAWINGS”, by Michal Hrcka, and Lance Grow, Attorney Docket No. 30566.488-US-U1, which is incorporated by reference herein.

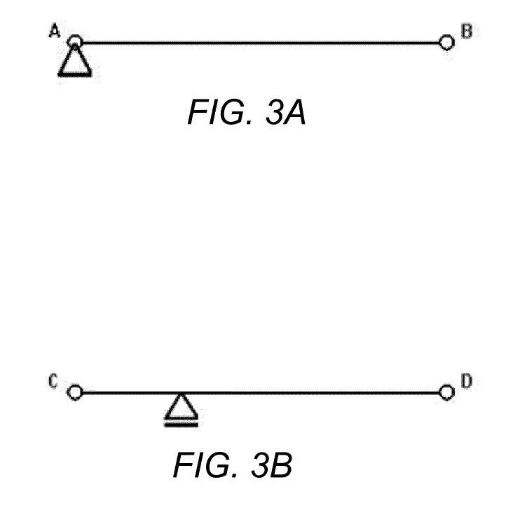

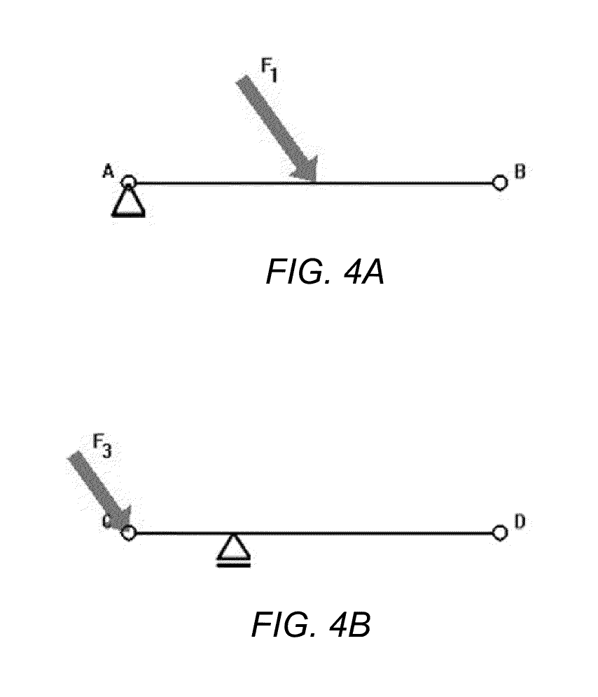

An example of two simple mechanisms in a free body diagram are illustrated in FIGS. 3A and 3B. Referring to FIG. 3A, The support at point A allows the AB beam to rotate, so it has one degree of freedom. Any load applied to beam AB at a point other than A will make beam AB rotate. Referring to FIG. 3B, the support on beam CD allows beam CD to rotate and also slide (e.g., from left to right). Accordingly, any load applied to beam CD will make the beam move. FIG. 4A illustrates the application of force F1 to the beam AB of FIG. 3A. FIG. 4B illustrates the application of force F3 to termination point C on beam CD of 3B. The application of either force F1 or F3 will cause the beams to start to move. Accordingly, the mechanisms of FIGS. 3A, 3B, 4A, and 4B are not in equilibrium and are not statically determinate systems.

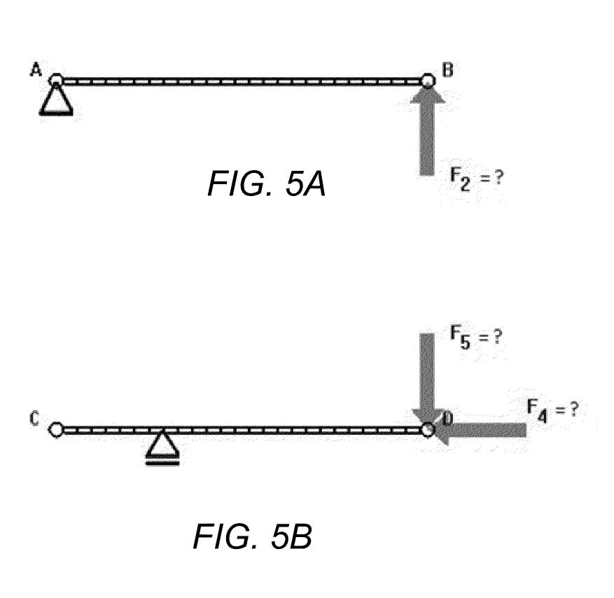

To determine the effect of various forces (e.g., forces F1 and F3), embodiments of the invention apply a variable force of unknown size, but with a fixed angle at point B, and a variable force of unknown size and angle at point D. FIGS. 5A and 5B illustrate the application of such variable forces F2, F4, and F5 (i.e., the variable forces shown decomposed to the x-axis and y-axis constituent parts). Such forces (F2, F4 and F5) have a drive value (of unknown size) that prevents the beams AB and CD from falling down or moving left/right.

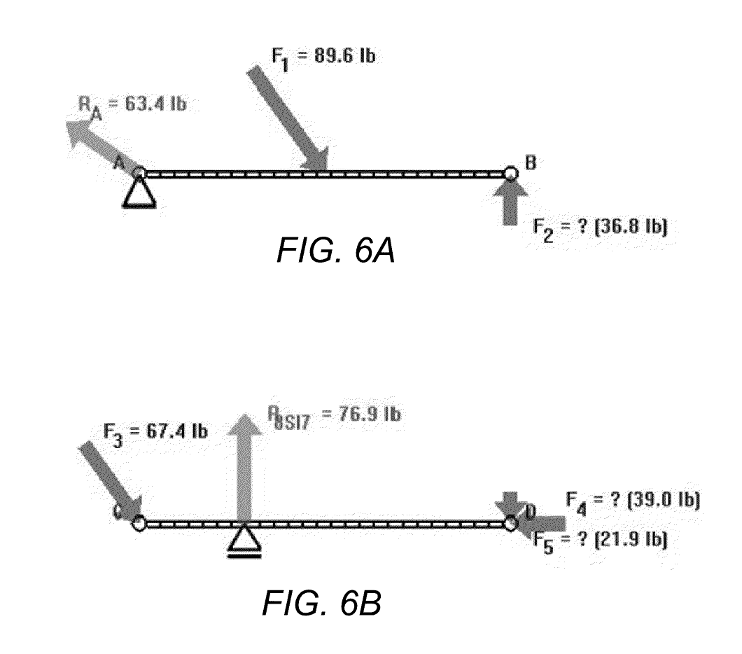

From such forces (F2, F4, and F5), the systems can become stable under some pressure. In other words, when the original loads (i.e., F1 and F3) are applied again, the equilibrium solution can be found/determined. FIGS. 6A and 6B illustrate the application of all of the forces as well as the resulting reactions (R) in the supports. In FIGS. 6A and 6B, F1 and F3 are the same, known, loads illustrated in FIGS. 4A and 4B. The reaction in the support (A) on beam AB is R_{A}=63.4 lb. Similarly, the reaction in the support (C) on beam CD is R_{8S17}=76.9 lb. Such reactions are based on the size of the variable forces F2, F4 and F5 that are solved. The computation for the size of the variable forces are based on a determination of what size forces are needed such that the system will not move (e.g., based on an angle for a variable force made of F4=F5). Thus, the system is solved in a manner similar to as if there is a sliding support (e.g., at points B and D).

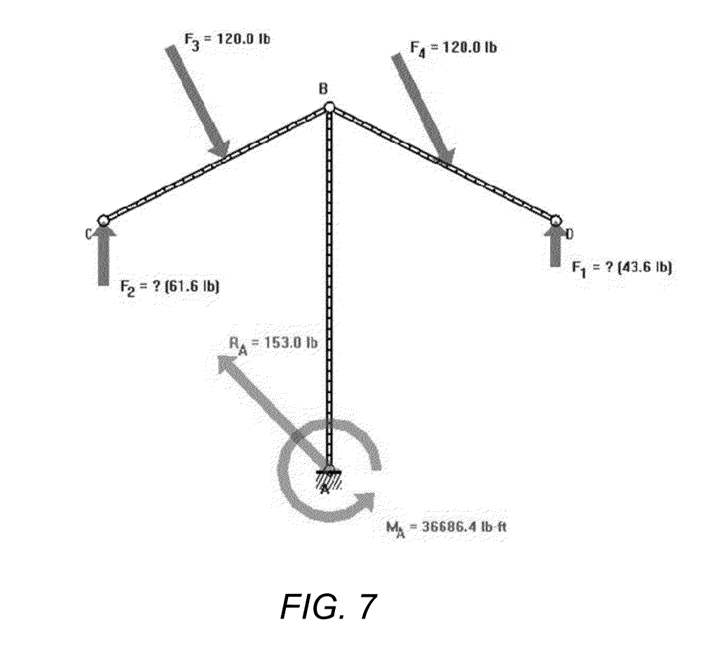

FIG. 7 illustrates a more complicated three beam construction where variable forces are again used to calculate the various effects in accordance with one or more embodiments of the invention. In FIG. 7, a mechanism is illustrated with more beams and that is balanced based on the variable forces. In FIG. 7, beam AB is grounded at point A (i.e., it cannot move or rotate). Beams CB and DB are connected through a (rotating) pin at B, so both beams CB and DB can rotate independently. Two distinct variable forces F1 and F2, one on each beam, have to be used to place the system in equilibrium. In other words, in order for the two beams CB and DB to not fall down, the beams need to be pushed on using unknown forces F1 and F2. Once the unknown forces are applied, additional forces (F3 and F4) (e.g., representing rain/snow, etc.) may be placed on the beams CB and DB but the system still remains in equilibrium. The resulting force (and angle) on the grounded support is illustrated as R_{A}=153.0 lb and M_{A}=36686.4 lb-ft.

In view of the above, one may note that embodiments of the invention utilize an unknown force at various points in a system in order to maintain a balanced system (i.e., in equilibrium). When the calculations are performed, the unknown force may be replaced (e.g., temporarily) with a sliding pin (i.e., in order to complete the calculations).

One may note that the calculations that are performed are that of a statically determinate system as known in the art (e.g., see Physics for Scientists and Engineers with Modern Physics, Section 5.7, Seventh Edition, Brooks/Cole Cengage Learning, 2008 which is incorporated by reference herein) (also see Mechanics of Solids and Structures, by David W. A. Rees, Imperial College Press, 2000, which is incorporated by reference herein).

### Logical Flow

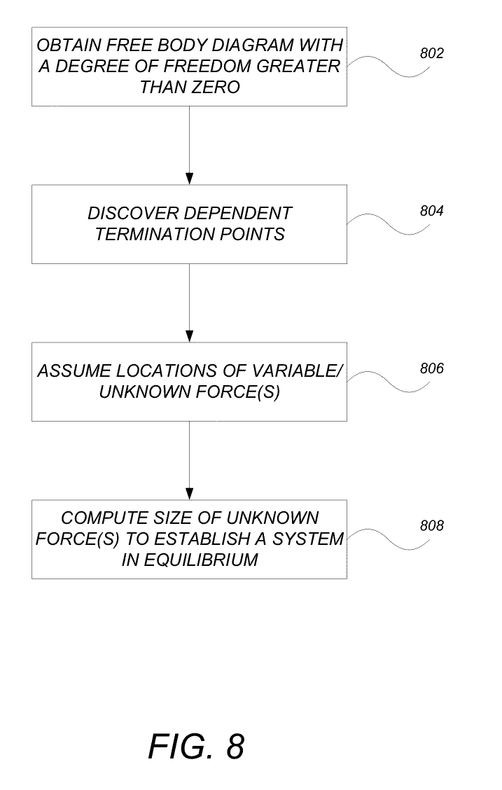

FIG. 8 illustrates the logical flow for creating a system equilibrium using an unknown force(s) in accordance with one or more embodiments of the invention.

At step 802, a free body diagram with a degree of freedom greater than zero is obtained (e.g., in a computer drawing program, CAD program, etc.).

At step 804, for each beam that has more than one degree of freedom, a point on that beam that is movable is discovered/found. In other words, any point of this beam except for one potentially fixed end point is found.

At step 806, variable/unknown forces are assumed to exist at the movable point discovered in step 804. Such variable unknown forces may be applied at those points. Such forces may be applied at a defined angle and may be broken up into multiple forces applied in constituent x and y directions. Alternatively, the user may place the unknown force wherever desired. Once an unknown force is placed/assumed to exist at a particular location, the resulting diagram is checked to determine if the degree of freedom (e.g., of the entire diagram) is less than zero (0) (i.e., DOF<=0). To determine the degree of freedom, the subject matter described in copending application cross referenced above entitled “GRAPH BASED DEGREE OF FREEDOM COUNTER FOR TWO DIMENSIONAL DRAWINGS”, by Michal Hrcka, and Lance Grow, Attorney Docket No. 30566.488-US-U1 may be used. If the degree of freedom is less than zero, the process proceeds to step 808. If not, the unknown force may be moved to a different location (i.e., automatically or via input from the user).

At step 808, compute a size of the unknown force(s), such that when applied, the free body diagram will be in equilibrium. Such a computation may also involve computing the angle of the unknown force(s) and may further involve more than one unknown force. Once computed, the force(s), angles, computations, etc. may be output such as transmitted across a network, displayed to a user, printed, etc.

### Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention provide the ability to utilize an unknown force(s) to create a system in equilibrium.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for solving a not-statically determinate modeling system comprising:
obtaining a free body diagram (FBD) with a degree of freedom (DOF) greater than zero;
for each beam in the FBD that has more than one DOF, discovering a point of the beam that is movable;
applying a variable force at the point;
determining a DOF of the FBD based on the application of the variable force; and
based on the determining, computing a size of the variable force that places the FBD in equilibrium.

2. The method of claim 1, wherein:
the point comprises an end point that is at an opposite end of where an existing force is applied to the beam.

3. The method of claim 1, wherein:
the variable force is applied at a defined angle.

4. The method of claim 1, wherein:
the variable force is broken up into multiple forces applied in constituent x and y directions.

5. The method of claim 1, wherein the determining the DOF of the FBD comprises:
determining that the DOF is less than zero; and
moving the variable force to a different location.

6. The method of claim 1, wherein:
the computing computes an angle of the variable force.

7. The method of claim 1, wherein:
the computing involves more than one variable force.

8. A computer readable storage medium encoded with computer program instructions which when accessed by a computer cause the computer to load the program instructions to a memory therein creating a special purpose data structure causing the computer to operate as a specially programmed computer, executing a method of solving a not-statically determinate modeling system, comprising:
obtaining, in the specially programmed computer, a free body diagram (FBD) with a degree of freedom (DOF) greater than zero;
for each beam in the FBD that has more than one DOF, discovering, in the specially programmed computer, a point of the beam that is movable;
applying, in the specially programmed computer, a variable force at the point;
determining, in the specially programmed computer, a DOF of the FBD based on the application of the variable force; and
based, in the specially programmed computer, on the determining, computing a size of the variable force that places the FBD in equilibrium.

9. The computer readable storage medium of claim 8, wherein:
the point is an end point that is at an opposite end of where an existing force is applied to the beam.

10. The computer readable storage medium of claim 8, wherein:
the variable force is applied at a defined angle.

11. The computer readable storage medium of claim 8, wherein:
the variable force is broken up into multiple forces applied in constituent x and y directions.

12. The computer readable storage medium of claim 8, wherein the determining the DOF of the FBD comprises:
determining, in the specially programmed computer, that the DOF is less than zero; and
moving, in the specially programmed computer, the variable force to a different location.

13. The computer readable storage medium of claim 8, wherein:
the computing computes an angle of the variable force.

14. The computer readable storage medium of claim 8, wherein:
the computing involves more than one variable force.

15. An apparatus for solving a not-statically determinate modeling system in a computer system comprising:
(a) a computer having a memory;
(b) an application executing on the computer, wherein the application is configured to:
(1) obtain a free body diagram (FBD) with a degree of freedom (DOF) greater than zero;
(2) for each beam in the FBD that has more than one DOF, discover a point of the beam that is movable;
(3) apply a variable force at the point;
(4) determine a DOF of the FBD based on the application of the variable force; and
(5) based on the determining, compute a size of the variable force that places the FBD in equilibrium.

16. The apparatus of claim 15, wherein:
the point is an end point that is at an opposite end of where an existing force is applied to the beam.

17. The apparatus of claim 15, wherein:
the variable force is applied at a defined angle.

18. The apparatus of claim 15, wherein:
the variable force is broken up into multiple forces applied in constituent x and y directions.

19. The apparatus of claim 15, wherein the application is configured to determine the DOF of the FBD by:
determining that the DOF is less than zero; and
moving the variable force to a different location.

20. The apparatus of claim 15, wherein:
the computing computes an angle of the variable force.

21. The apparatus of claim 15, wherein:
the computing involves more than one variable force.
